(19) United States
(12) Patent Application Publication
(10) Pub. No.: US 2026/0126091 A1
(43) Pub. Date: May 7, 2026

(54) Heavy Vehicle Brake Assembly

(71) Applicant: MERITOR HEAVY VEHICLE BRAKING SYSTEMS (UK) LIMITED, Cwmbran Gwent (GB)

(72) Inventors: Sean CLEARY, Cwmbran Gwent (GB); Paul A. THOMAS, Cwmbran Gwent (GB); Rhys WATKINS, Cwmbran Gwent (GB); Simon DUGGAN, Cwmbran Gwent (GB); Daniel JENKINS, Cwmbran Gwent (GB); Gopala K. VENUGOPALA, Cwmbran Gwent (GB)

(21) Appl. No.: 19/493,226

(22) PCT Filed: Jun. 14, 2024
(86) PCT No.: PCT/EP2024/066627

§ 371 Date: Dec. 15, 2025

(30) Foreign Application Priority Data
Jun. 14, 2023 (EP) 23179290.4

(51) Int. Cl. F16D 66/02; F16D 51/20; F16D 55/225; F16D 65/09; F16D 65/095

(52) U.S. Cl. CPC F16D 66/021; F16D 65/09; F16D 65/095; F16D 51/20; F16D 55/225

(57) ABSTRACT

A heavy-vehicle brake assembly includes a braking element including friction material having an engaging face, the braking element configured to be actuated in a braking operation so that the engaging face of the friction material engages a braking surface to slow a heavy-vehicle; and a wear sensor assembly. The wear sensor assembly comprises: an ultrasonic sensor for emitting and detecting high-frequency sound waves; and a sacrificial member having an engaging face arranged to face the braking surface, wherein the sacrificial member is arranged such that sound waves emitted by the ultrasonic sensor pass through the sacrificial member; wherein the engaging face of the sacrificial member is flush with the engaging face of the friction material of the braking element and the sacrificial member is configured to actuate together with the braking element during the braking operation so that the engaging face of the sacrificial member also engages the braking surface.

### CROSS-REFERENCE TO RELATED APPLICATIONS

This application is the U.S. National Phase of PCT/EP 2024/066627 Filed Jun. 14, 2024, which claims priority to EP 23179290.4 Filed Jun. 14, 2023, the disclosure of which is hereby incorporated in its entirety by reference herein.

### TECHNICAL FIELD

The present disclosure relates to a heavy vehicle brake assembly, particularly to a wear sensor assembly for determining the wear of braking elements.

### BACKGROUND

There are various methods for detecting wear in brakes for heavy vehicles. Such systems are an important safety feature because they help ensure that braking elements are replaced before they become too worn to provide effective stopping power. This can help prevent accidents and increase the overall safety of the vehicle. Additionally, by detecting wear early, such systems can help reduce maintenance costs by allowing brake elements to be replaced before they cause damage to other parts of the brake system, such as the brake rotors or drums.

In some brakes, a pad wear warning indicator (PWWI) device is provided. This is typically a device that is located within the friction material of a braking element of the brake. When the friction material has worn to a predetermined amount, the PWWI will come into contact with the braking surface (e.g. the surface of a brake rotor in a disc brake or an inner surface of a brake drum in a drum brake) and make a noise that acts as a signal to the user that the braking element should be replaced. In other arrangements, a wire is located in the friction material that is in a loop to create a circuit. When the friction material is worn by enough, the circuit is broken to indicate that the friction material has reached a wear threshold.

Alternatively, a more advanced solution is to include a constant wear sensor (CWS). Known CWS systems measure an internal component of the brake to estimate total friction wear. For example, in a disc brake, a CWS will measure the expansion of the adjuster mechanism to estimate total frictional wear, which is made up of the wear of the inboard brake pad, the outboard brake pad and the brake rotor.

It would be desirable, however, to provide live measurements of the wear of individual braking elements as this could help diagnose issues with the brake such as differential wear.

### SUMMARY

A first aspect of the present teachings provides a heavy-vehicle brake assembly, comprising: a braking element including friction material having an engaging face, the braking element configured to be actuated in a braking operation so that the engaging face of the friction material engages a braking surface to slow a heavy-vehicle; and a wear sensor assembly comprising: an ultrasonic sensor for emitting and detecting high-frequency sound waves; and a sacrificial member having an engaging face arranged to face the braking surface, wherein the sacrificial member is arranged such that sound waves emitted by the ultrasonic sensor pass through the sacrificial member; wherein the engaging face of the sacrificial member is flush with the engaging face of the friction material of the braking element and the sacrificial member is configured to actuate together with the braking element during the braking operation so that the engaging face of the sacrificial member also engages the braking surface.

Ultrasonic (US) sensors are known for thickness measurement by monitoring the time delay between sending and receiving of a signal. However, it has been found that such US sensors are not suitable for measuring the remaining friction material of a braking element due to complexities introduced by there being a combination of materials (e.g. a steel backplate and a different friction material) as well as the isotropic nature of friction materials (typically a non-uniform compound with high metallic content). However, with the current arrangement, as the engaging face of the sacrificial member and the engaging face of the friction material are flush, they both engage the braking surface during a braking operation and wear at the same rate. Accordingly, sound waves emitted by the ultrasonic sensor through the sacrificial member are detected in order to provide data indicating the amount of material remaining in the sacrificial member. This data can then be used to determine the wear of the friction material, which will correspond to the wear of the sacrificial member. This can enable live monitoring of the wear of the individual braking elements without requiring any change to the composition of the friction material or the structure of the braking element. This arrangement can also be retrofitted to existing heavy-vehicle brakes.

The sacrificial member may be fixed relative to the braking element.

This helps to ensure that the sacrificial member and the braking element actuate together during the braking operation.

The sacrificial member may be fixed to the braking element.

Fixing the sacrificial member to the braking element further helps to ensure that the sacrificial member and the braking element actuate together during the braking operation. In addition, it means that the sacrificial member and braking element could be provided as a single assembly and could potentially help to restrict the use of unauthorised replacement braking elements, which are a safety issue.

The braking element may comprise a recess extending through the friction material. The sacrificial member may be located within this recess.

This location helps to ensure that the friction material and sacrificial element will both engage the braking surface during the braking operation. This location has been used in previous brake assemblies to locate a known pad wear warning indicator device and so is a convenient location as such a device may no longer be necessary and so the location can be repurposed by the sacrificial member for existing braking elements and no modification would be needed to manufacturing processes for producing new braking elements.

The recess in the friction material may be spaced from radial and circumferential edges of the braking element.

This helps to ensure that the sacrificial member contacts the braking surface and does not interfere with actuation of the brake during the braking operation.

The sacrificial member may be arranged between the ultrasonic sensor and the braking surface.

This helps to ensure that the high-frequency sound waves from the ultrasonic sensor pass through the sacrificial member and impact the engaging face of the sacrificial member, so some can be reflected back towards the ultrasonic sensor and detected to enable the amount of material removed from the sacrificial member in the direction of the braking surface can be determined.

The sacrificial member may be fixed to the ultrasonic sensor.

This enables the sacrificial member and ultrasonic sensor to be provided together as a single assembly and helps to ensure that the ultrasonic sensor is optimally aligned with respect to the sacrificial member.

The sacrificial member may be elongate and arranged with its longitudinal axis extending in a direction perpendicular to the engaging face of the friction material of the braking element.

This helps to ensure that the sacrificial member extends by a sufficient length to match the depth of the friction material of the braking element but reduces the cross-sectional area of the sacrificial member in contact with the braking surface relative to the area of friction material in contact with the braking surface so performance of the brake is not significantly negatively impacted.

The sacrificial member may be cylindrical. The sacrificial member may be located within a corresponding cylindrical recess of a housing arranged to locate the ultrasonic sensor.

This is a convenient shape to manufacture and helps a user to correctly install the sacrificial member during assembly as the exact rotational orientation about the longitudinal axis is immaterial.

The sacrificial member may be formed of a homogenous material.

This material helps to ensure that the sound waves from the ultrasonic sensor pass through the sacrificial member easily and can be detected without significant interference affecting the signal.

The material of the sacrificial member may be heat resistant. The material may have a similar compressibility as the friction material of the braking element.

This helps to ensure that the engaging face of the sacrificial member remains flush with the engaging face of the braking element and that the sacrificial member does not wear too quickly.

The material of the sacrificial member may be configured to be softer than the braking surface.

Advantageously, this helps to ensure proper function and helps to avoid damage to the braking surface.

In a second aspect, a drum brake is provided comprising the heavy-vehicle brake assembly of the previous aspect. The braking surface is an inner surface of a drum rotationally fixed relative to a vehicle wheel. The braking element is a brake shoe having brake linings of friction material.

The drum brake may comprise a plurality of sacrificial members and a plurality of brake shoes. Each sacrificial member may correspond to one of the brake shoes.

With multiple sacrificial members, each sacrificial member corresponding to one of multiple brake shoes, differential wear can be detected, i.e. when the friction material of one brake shoe is wearing at a different rate to the friction material of one of the other brake shoes. This information is useful in preventing more serious safety issues, as it can be an indicator of a fault in the brake.

In a third aspect, a disc brake is provided comprising the heavy-vehicle brake assembly of the first aspect. The braking surface is a rotor rotationally fixed relative to a vehicle wheel and the braking element is a brake pad having friction material. The brake pad may have a backplate. The friction material may be fixed to the backplate.

The disc brake may comprise a plurality of sacrificial members and a plurality of brake pads, wherein each sacrificial member corresponds to one of the brake pads.

With multiple sacrificial members, each sacrificial member corresponding to one of multiple brake pads, differential wear can be detected, i.e. when the friction material of one brake pad is wearing at a different rate to the friction material of one of the other brake pads. This information is useful in preventing more serious safety issues, as it can be an indicator of a fault in the brake.

In a fourth aspect, a heavy vehicle brake assembly is provided comprising: a braking element including friction material, the braking element configured to be actuated in a braking operation in the direction of a braking surface so that an engaging face of the friction material contacts the braking surface to slow a heavy vehicle; and a wear sensor assembly for detecting the wear of the friction material, the wear sensor assembly configured to be actuated together with the braking element during the braking operation so that an engaging face of the wear sensor assembly also contacts the braking surface. The wear sensor assembly comprises a compliant arrangement configured to allow compression of the wear sensor assembly when the engaging face of the wear sensor assembly contacts the braking surface.

When the braking element and wear sensor assembly contact the braking surface, the wear sensor assembly can compress due to the compliant arrangement. As the friction material will compress during a braking operation, this helps to ensure that the wear sensor assembly compresses at least as much as the friction material. This helps to avoid a risk that the wear sensor assembly will project from the friction material because the friction material has compressed to a greater extent. i.e. the engaging face of the wear sensor assembly is co-planar with the engaging face of the friction material. This would be undesirable as the majority of the reaction force from the braking element contacting the braking surface to slow the vehicle could pass through the wear sensor assembly and damage its delicate components. The compliant arrangement helps to ensure that the majority of the reaction force is instead distributed around the wear sensor assembly. For example, much of the reaction force will pass around the wear sensor assembly along a load path that goes through the friction material to a support surface of the braking element, and then to a fixed component of a vehicle brake such as a brake carrier or brake caliper.

The compliant arrangement may comprise a resilient element configured to be compressed during the braking operation and expand after the braking operation to move the engaging face of the wear sensor assembly in the direction of the braking surface.

The resilient element can be compressed to help ensure that the wear sensor assembly does not project from the friction material as the friction material is compressed. The resilient element will then expand again once the brake is released then helps to ensure that the engaging face of the wear sensor assembly is moved back towards the braking surface, so it is in the correct location for a subsequent braking operation.

The compliant arrangement may comprise a first member fixed relative to the braking element and a second member fixed relative to the wear sensor assembly. The second member may be movable relative to the first member along an axis that is perpendicular to the braking surface.

As the first and second members can move relative to one another but are grounded to different components, the wear sensor assembly can move relative to the braking element, and therefore compress and expand towards and away from the braking surface.

The resilient element may be located between the first member and the second member of the compliant arrangement.

This is a compact arrangement that enables the wear sensor assembly to be compressed and expanded as required.

The resilient element may be located between radially extending opposing surfaces of the first member and the second member.

The radially extending surfaces provide suitable surfaces for the resilient element to act on, in order to move the second member relative to the first member along the axis, i.e., towards and away from the braking surface.

The second member may be located radially inwardly of the first member.

This helps to reduce the space required by the compliant arrangement.

The braking element may have a support surface for the friction material. The support surface and/or friction material may comprise a slot or a recess to locate the wear sensor assembly.

The slot or recess provides a convenient location for the wear sensor assembly to help ensure it is correctly positioned relative to the braking element.

The support surface and friction material may each have a perimeter. The slot may intersect the perimeter of the support surface and the perimeter of the friction material.

As the slot intersects the perimeter of the support surface and the perimeter of the friction material, assembly is aided as the wear sensor assembly can simply be inserted into the slot to install it in place. This can help, for example, if the braking element is already located in a brake, enabling the wear sensor assembly to be installed from above without removing the braking element from the brake.

The first member of the compliant arrangement may locate in the slot of the support surface. The first member of the compliant arrangement may be fixed to the support surface of the braking element. The first member may be a clip configured to locate in the slot of the support surface with an interference fit. The second member may be a sleeve configured to slide within the clip. The slot and the clip may be substantially U-shaped.

The clip can be installed in a simple way and fixed to the support surface without the need for any additional components or further operations. The U-shape of the slot and clip enable the sleeve to be easily inserted.

The support surface and friction material may each have a perimeter. The support surface and friction material may comprise a recess in the form of a through hole spaced from the perimeter of the support surface and the perimeter of the friction material.

This an alternative method of assembly where, for example, the wear sensor assembly can be passed through the support surface from a rear face opposite the front face that supports the friction material. This aids assembly as the wear sensor assembly is guided by the through hole during installation so will have the correct location.

At least a portion of the second member of the compliant arrangement may locate in the through hole of the support surface. The first member may be fixed to the support surface of the braking element. The second member may be fixed to the support surface by an elongate fastening element. The first member may be configured to slide on the fastening element relative to the second member. The fastening element may locate a resilient element.

This provides a reaction surface for the compliant arrangement and creates a load path through the support surface of the braking element.

The extent of relative movement between the first member and the second member may be limited by at least one stop surface.

The stop surface enables the amount of relative movement of the first and second members to be controlled as desired. This helps to ensure the amount of relative movement is not too large.

The braking element may have a support surface for the friction material. The stop surface may be on the second member. The stop surface may be configured to contact the support surface or the first member to limit return movement towards the braking surface.

This helps to ensure correct relative positioning and engaging faces staying flush before next braking operation.

The stop surface may be a first stop surface. The second member may further comprise a second stop surface for contacting the support surface or the first member to limit actuation movement away from the braking surface.

The second member may be a sleeve having first and second radially extending flanges. The first stop surface may be on the first flange. The second stop surface may be on the second flange.

The wear sensor assembly may further comprise: an ultrasonic sensor for emitting and detecting high-frequency sound waves; and a sacrificial member having the engaging face of the wear sensor assembly that is arranged to face the braking surface, wherein the sacrificial member is arranged such that sound waves emitted by the ultrasonic sensor pass through the sacrificial member.

As the engaging surface of the sacrificial member is flush with the engaging surface of the friction material during a braking operation, the sacrificial member will wear at the same rate as the friction material. By detecting the amount of wear of the sacrificial member, the wear of the friction material can be determined.

Each resilient element may be a spring washer, a wavy washer, a spring or a compressible spacer.

Such resilient elements are particularly suitable for the current application where the amount of deflection is low. They are easy to assemble and widely available.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim, or file any new claim, accordingly, including the right to amend any originally filed claim to depend from and/or incorporate any feature of any other claim although not originally claimed in that manner.

### BRIEF DESCRIPTION OF DRAWINGS

One or more embodiments of the present disclosure will now be described, by way of example only, with reference to the accompanying drawings, in which:

FIG. 1A is a perspective view of a wear sensor assembly;

FIG. 1B is a side view of the wear sensor assembly of FIG. 1A;

FIG. 1C is a cross-sectional view of the wear sensor assembly of FIG. 1A through the plane 1C-1C;

FIG. 2 is a perspective view of a heavy vehicle disc brake;

FIG. 3 is a cross-sectional view of the heavy vehicle disc brake of FIG. 2 through the plane 2-2, including the wear sensor assembly of FIG. 1A ;

FIG. 4 is a close-up view of part of FIG. 3;

FIG. 5 is a perspective view of an alternative heavy vehicle disc brake;

FIG. 6 is a cross-sectional view of the heavy vehicle disc brake of FIG. 5 through the plane 6-6, including the wear sensor assembly of FIG. 1A ;

FIG. 7 is a perspective view of a heavy vehicle drum brake;

FIG. 8 is a cross-sectional view of the heavy vehicle drum brake of FIG. 7 through the plane 8-8, including the wear sensor assembly of FIG. 1A ; and

FIG. 9 is a close-up view of part of FIG. 8;

FIG. 10 is a perspective view of an alternative heavy vehicle braking assembly;

FIG. 11 is a cross-sectional view of the heavy vehicle braking assembly of FIG. 10 through the plane 11-11;

FIG. 12 is a perspective view of a wear sensor assembly of the heavy vehicle braking assembly of FIG. 10; and

FIG. 13 is an exploded view of the wear sensor assembly of FIG. 12;

FIG. 14 is a perspective view of an alternative heavy vehicle braking assembly;

FIG. 15 is a front view of the heavy vehicle braking assembly of FIG. 14;

FIG. 16 is a cross-sectional view of the heavy vehicle braking assembly of FIGS. 14 and 15 through the plane 16-16, with the wear sensor assembly in a first condition;

FIG. 17 is a cross-sectional view of the heavy vehicle braking assembly of FIGS. 14 and 15 through the plane 16-16, with the wear sensor assembly in a second condition;

FIG. 18 is a perspective view of a wear sensor assembly of the heavy vehicle braking assembly of FIG. 14;

FIG. 19 is an exploded view of the wear sensor assembly of FIG. 18; and

FIG. 20 is an exploded view of the heavy vehicle braking assembly of FIG. 10.

### DETAILED DESCRIPTION

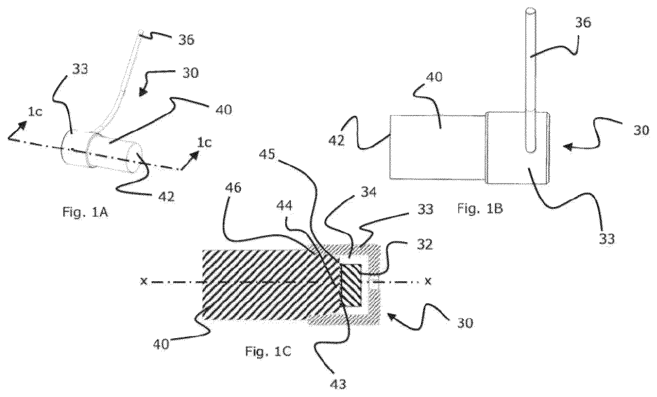

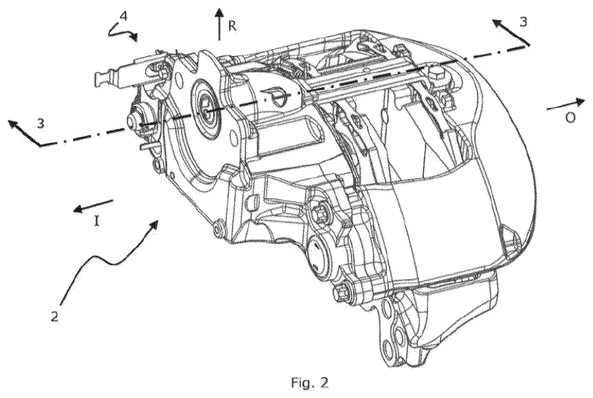

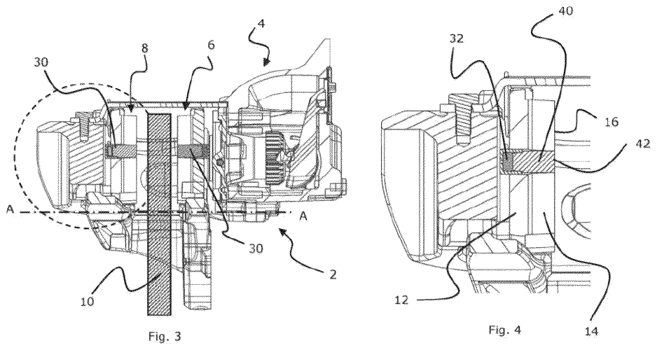

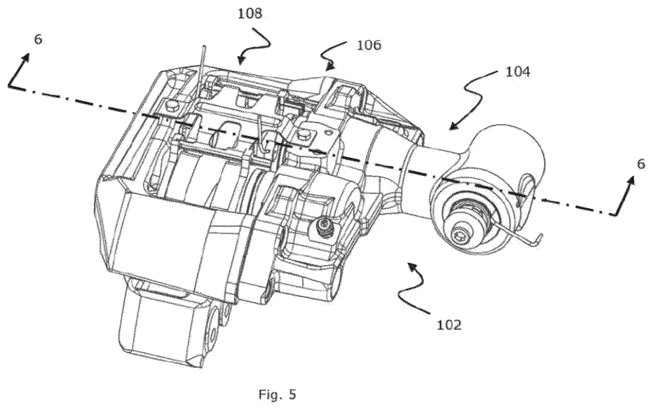

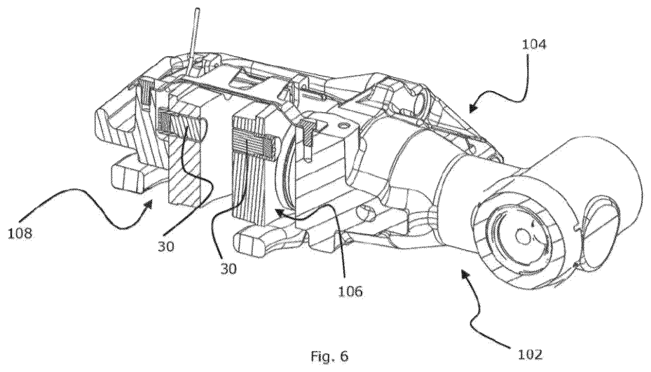

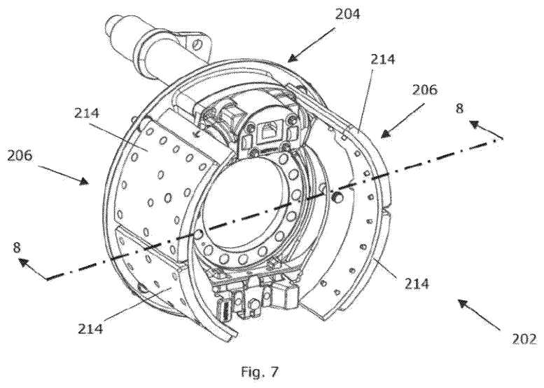

FIGS. 1A to 1C show a wear sensor assembly 30. The wear sensor assembly 30 is for determining the amount of wear of friction material of a braking element and can be used in a range of different heavy-vehicle brakes, as shown in the examples of FIGS. 2 to 9 and described in more detail below. FIGS. 2 to 4 show an air-actuated disc brake 2 including the wear sensor assembly 30, FIGS. 5 and 6 show a hydraulically-actuated disc brake 102 including the wear sensor assembly 30, and FIGS. 7 to 9 show a drum brake 202 including the wear sensor assembly 30

Looking firstly at FIGS. 1A to 1C, the wear sensor assembly 30 is shown in detail. In this embodiment, the wear sensor assembly 30 includes a housing 33, an ultrasonic sensor 32 for emitting and detecting high-frequency sound waves; and a sacrificial member 40. The ultrasonic sensor 32 is any suitable sensor including a transducer for producing high-frequency ultrasonic sound waves, which are emitted from the sensor and reflected back by hard surfaces or an interface between two different materials, e.g., in this embodiment by an interface between the sacrificial member 40 and the air. Examples of suitable transducers are piezoelectric transducers or electro-magnetic acoustic transducers (EMAT). The detected returning sound waves can be transmitted by a connecting wire 36, or wirelessly in other embodiments, to a suitable controller (not shown) where the data transmitted can be used to determine, for example, the amount of material in the sacrificial member 40, e.g., to determine. its current length. As will be explained below, such data can then be used to determine the amount of wear of the friction material of a braking element.

In this embodiment, the sacrificial member 40 is elongate with a longitudinal axis x-x. In this embodiment, the sacrificial member is cylindrical, i.e. it has a circular cross-section, though it will be appreciated that there are a range of different possible shapes that would still allow the sacrificial member 40 to achieve its function. For example, the sacrificial member 42 could have a square cross-section, triangular cross-section or any other suitable shape. In this embodiment, the sacrificial member 40 has a narrowed end portion 44 with a reduced outer diameter and lower cross-sectional area than the remainder of the sacrificial member 40. The end portion 44 has an end face 45 configured to face the ultrasonic sensor 32 as described in more detail below. A stepped portion 46 connects the end portion 44 to the remainder of the sacrificial member 40. In this embodiment, the stepped portion 46 and end portion 44 help the sacrificial member 40 to more easily locate within a recess 34 of the housing 33 In this embodiment, the recess 34 is a cylindrical cavity to correspond to the cylindrical sacrificial member 40, but it will be appreciated that the recess 34 could also be any suitable shape. In this embodiment, the sacrificial member 40 is fixed to the housing 33 with a suitable adhesive, but in other embodiments the sacrificial member 40 and the housing 33 could each have corresponding threads and be screwed to one another. Further, the ultrasonic sensor 32 is located within the housing so the sacrificial member 40, housing 33 and ultrasonic sensor 32 can all be provided as a single wear sensor assembly 30. Typically, the remainder of the recess 34 of the housing can be filled with an epoxy resin or similar to locate the ultrasonic sensor 32. A through bore in the end face of the housing 33 helps enable this, as the recess 34 can be filled and the excess exits through the through bore. However, it will be appreciated that in other embodiments the components could be all be provided separately, as long as the sacrificial member 40 is arranged between the ultrasonic sensor 32 and the braking surface of the brake, such that the sound waves from the ultrasonic sensor 32 pass through the sacrificial member 40 and are reflected back so they can be detected.

In this embodiment, a couplant 43 is provided between the ultrasonic sensor 32 and the end face 45 of the sacrificial member 40. In this embodiment, there is no air gap between the couplant 43 and the ultrasonic sensor 32 and the couplant 43 and the end face 45 of the sacrificial member 40. The couplant 43 acts as a bridge to help ensure the sound waves travel reliably into the sacrificial member 40 and the signal is not negatively affected by travelling through air. In this embodiment, the couplant 43 is a solid disc shape made from any suitable material. In other embodiments, however, the couplant 43 could be a viscous liquid, for example a silicon-based or glycol-based gel.

In this embodiment, the sacrificial member 40 is formed of a homogenous material as this helps to ensure that the sound waves from the ultrasonic sensor 32 pass through the sacrificial member 40 easily and can be detected without significant interference affecting the signal. Any suitable material could be used, but ideally the material of the sacrificial member should be heat resistant such that it can handle the high temperatures reached in a brake and have a similar compressibility as the friction material of the braking element. An example of a suitable material would be a thermoplastic such as Vespec®.

At an end of the sacrificial member 40 opposite the end portion 44 is an engaging face 42. The engaging face 42 is substantially perpendicular to the longitudinal axis x-x. As described in more detail below, when installed in a brake, the sacrificial member 40 is arranged with its longitudinal axis x-x extending in a direction perpendicular to an engaging face of the friction material of the braking element. As also described in more detail below, this helps to ensure that the engaging face 42 of the sacrificial member 40 member faces the braking surface and is flush with an engaging face of the friction material of the braking element.

FIGS. 2 to 4 show a disc brake 2. Various orientations of the disc brake 2 are described. In particular, the directions inboard I and outboard O refer to the typical orientation of the disc brake 2 when fitted to a vehicle and with reference to the longitudinal centreline of the vehicle. The radial direction R refers to an orientation with reference to the centre of a brake rotor (axis A-A) and is for example the direction in which brake pads may be fitted to and removed from a disc brake.

The function of such a disc brake 2 is well-known so will not be described in detail but, briefly, a brake carrier locates braking elements to face braking surfaces. In this case, the braking surfaces are opposite sides of a rotor 10 that is rotationally fixed to a vehicle wheel, and the braking elements are an inboard brake pad 6 and an outboard brake pad 8. An actuating arrangement 4 engages the inboard brake pad 6 to urge it towards the rotor 10 and a reaction force slides a caliper relative to the brake carrier in order to urge the outboard brake pad 8 towards the rotor 10. The inboard brake pad 6 and the outboard brake pad 8 each include a backplate 12 that locates friction material 14. The friction material 14 has an engaging face 16 that is arranged to face the rotor 10 such that during a braking operation, when the inboard brake pad 6 and outboard brake pad 8 are moved towards the rotor 10, the engaging faces 16 of the inboard brake pad 6 and the outboard brake pad 8 engage the opposite surfaces of the rotor 10 to slow the vehicle.

Over time, the friction material 14 of each of the inboard brake pad 6 and the outboard brake pad 8 will wear, and it would be beneficial to know when each brake pad 6, 8 should be replaced as well as when one of the brake pads 6, 8 is wearing more quickly than the other, as this could indicate a fault in the brake. To do this, in this embodiment a wear sensor assembly 30 is provided on either side of the rotor 10. Each sacrificial member 40 is arranged so that the engaging face 42 of the sacrificial member 40 is flush with the engaging face 16 of the friction material 14 of the inboard brake pad 6 or the outboard brake pad 8. The brake pad 6, 8 and the corresponding sacrificial member 40 are configured to actuate together during the braking operation so that the engaging face 42 of the sacrificial member 40 also engages the rotor 10. Therefore, as the friction material 14 wears, the sacrificial member 40 will wear at the same rate. Accordingly, sound waves emitted by the ultrasonic sensor 32 through the sacrificial member 40 will reflect back to the ultrasonic sensor 32 as they contact the engaging face 42, due to the interface between the material of the sacrificial member 40 and the air surrounding the sacrificial member 40. The reflected sound waves are detected by the ultrasonic sensor 32 in order to provide data indicating the time delay between the transmitting and receiving of the sound waves, which can indicate the amount of material remaining in the sacrificial member 40. This data can then be used to determine the wear of the friction material 14, as it will correspond to the wear of the sacrificial member 40, due to them being flush.

In this embodiment, the sacrificial member 40 is fixed to the brake pad 6, 8 by being located in a central region spaced from circumferential and radial edges of the brake pad 6, 8. In this embodiment, this central region comprises a recess 18 that extends through the friction material 14. In this embodiment, the recess 18 extends through the entire depth of the friction material in the axial direction, i.e. parallel to a central axis about which the rotor 10 rotates. In this embodiment, the recess 18 is of a circular cross-section to correspond to a cylindrical sacrificial member 40, but it could have any suitable cross-sectional shape. The recess 18 has been used in previous brake pads to locate a known pad wear warning indicator device, so the wear sensor assembly 30 could be retrofitted to existing brake pads 6, 8 in this location. It will be appreciated that in other embodiments, the ultrasonic sensor 32 and sacrificial member 40 could be located in any suitable location, provided the engaging face 42 of the sacrificial member 40 is flush with the engaging face 16 of the friction material 14 of the inboard brake pad 6 or the outboard brake pad 8 and the sacrificial member 40 and the inboard brake pad 6 or the outboard brake pad 8 actuate together during the braking operation.

To help prevent damage to the wear sensor assembly 30, it would be beneficial to help ensure that the load path through the sacrificial member 40 does not pass through the ultrasonic sensor 32 and cause damage to it. For example, the sacrificial member 40 could be elastic, or an alternative arrangement could be provided to ensure the load does not go into the ultrasonic sensor 32.

FIGS. 5 and 6 shown an alternative heavy vehicle brake. In this embodiment, a hydraulically-actuated disc brake 102 is shown, with an actuating arrangement 104 having hydraulically-actuated pistons for actuating an inboard brake pad 106 as well as a known parking brake arrangement for holding the brake 102 in the actuated position when required. The brake 102 also includes an outboard brake pad 108. As shown most clearly in FIGS. 6, like the embodiment of FIGS. 2 to 4, wear sensor assemblies 30 are provided on the inboard and outboard sides of the rotor (not shown).

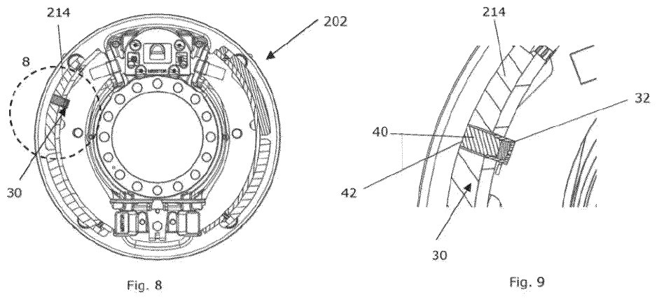

FIGS. 7 to 9 shown a further alternative heavy vehicle brake. In this embodiment, drum brake 202 is shown, with an actuating arrangement 204. In this embodiment, the braking elements are brake shoes 206 each having friction material 214. The operation of such a drum brake 202 is known, so will not be described in much detail but, briefly, during a braking operation the actuating arrangement 204 actuates the brake shoes 206 in a radially-outward direction such that the friction material 214 of each brake shoe engages an inner surface of a drum (not shown) that is rotationally fixed relative to a vehicle wheel, in order to slow the vehicle. As shown most clearly in FIG. 9, like the embodiments of FIGS. 2 to 6, wear sensor assemblies 30 are provided facing the braking surface (in this case the inner surface of the drum) and are flush with an engaging face 216 of the friction material 214. Accordingly, each wear sensor assembly 30 can detect the wear of the sacrificial member 40 so that the amount of wear of the friction material 214 can be determined.

Although embodiments are described with multiple wear sensor assemblies 30, it will be appreciated that this may not always be necessary, and a single wear sensor assembly 30 may be sufficient.

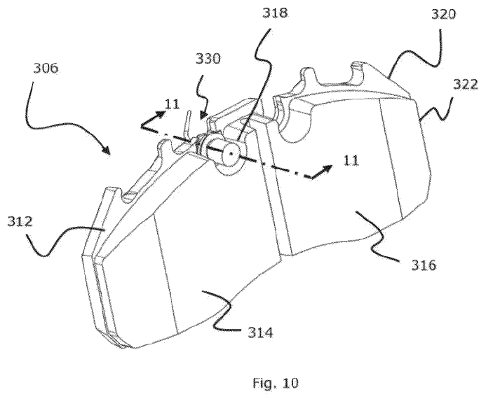

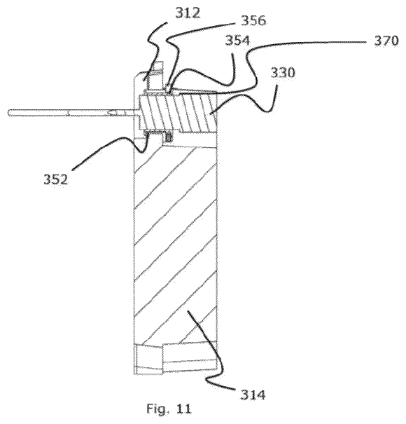

An alternative heavy vehicle brake assembly is described below and shown in FIGS. 10 to 13. Features that this brake assembly has in common with the previous arrangements are indicated with the same number, but with the prefix “3”, and these features will not be described in detail, to avoid duplication as much as possible.

There is a risk that damage can occur to the wear sensor assembly 330 if the load path during a braking operation passes through the ultrasonic sensor 332. For example, the couplant 333 could be burned off or damaged, creating an air gap. In addition, the ultrasonic sensor 332 itself could be crushed. In this embodiment, a compliant arrangement 350 is provided to help prevent this.

FIGS. 10 to 13 show the compliant arrangement 350 fixed to the inboard brake pad 306, as well as on its own, so the components of the compliant arrangement 350 can be seen in more detail. The function of the compliant arrangement 350 is to allow the engaging face 342 of the wear sensor assembly 330 to move relative to a support surface of a braking element. In this embodiment, the compliant arrangement 350 allows the engaging face 342 of the wear sensor assembly 330 to move relative to backplate 312 of the inboard brake pad 306 when the engaging face 316 of the friction material 314 and the engaging face 342 of the wear sensor assembly 330 contact the rotor 310. As the friction material 314 will compress during a braking operation, this helps to ensure that the wear sensor assembly 330 compresses at least as much as the friction material. This helps to avoid a situation where the wear sensor assembly 330 projects from the friction material 314 as the friction material 314 has compressed to a greater extent, i.e., the engaging face 342 of the wear sensor assembly 330 is no longer substantially flush with the engaging face 316 of the friction material 314. This would be undesirable as much of the reaction force from the braking element contacting the braking surface to slow the vehicle could pass through the wear sensor assembly 330 and damage its delicate components. The compliant arrangement 350 helps to ensure that most of the reaction force is instead distributed around the wear sensor assembly 330. For example, most of the reaction force will pass around the wear sensor assembly 330 along a load path that goes through the friction material 314 to a support surface of the braking element such as the backplate 312, and then to a component of a vehicle brake fixed relative to a wheel such as a brake carrier or brake caliper.

As can be seen most clearly in FIG. 10, in this embodiment, the backplate 312 and friction material 314 include a slot 318 for locating the wear sensor assembly 330. The slot 318 extends in an axial direction through the thickness of the backplate 312 and the friction material 314. In this embodiment, the slot 318 extends through the entire thickness of the backplate 312 and the friction material 314 but it will be appreciated that in other embodiments, the slot 318 may only extend partially through one or both of the backplate 312 and the friction material 314. In this embodiment, the slot 318 intersects a perimeter 320 of the backplate 312 as well as a perimeter 322 of the friction material 314. The slot 318 is substantially semi-circular but it will be appreciated that in alternative embodiments it could have any suitable shape, to correspond to the shape of the wear sensor assembly 330. In this embodiment, the slot 318 intersects radially upper surfaces of the backplate 312 and friction material 314. Advantageously, this aids assembly as the wear sensor assembly 330 can simply be inserted into the slot 318 in a radially inward direction to install it in place. This can help, for example, if the inboard brake pad 306 is already located in the brake 302, enabling the wear sensor assembly 330 to be installed from above without removing the inboard brake pad 306 from the brake 302. As will be described in more detail below, part of the compliant arrangement 350 is fixed to the backplate 312 and the remainder of the wear sensor assembly 330 locates in the slot 318.

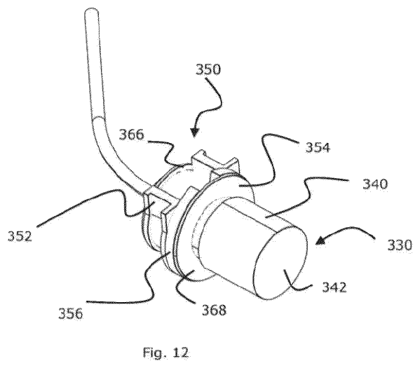

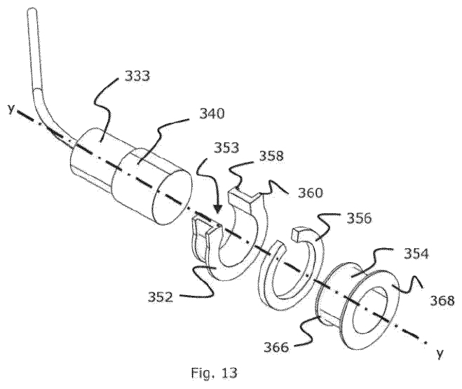

FIGS. 12 and 13 show the compliant arrangement 350 of the wear sensor assembly 330 in more detail. In this embodiment, the compliant arrangement 350 includes a first member fixed relative to the backplate 312 of the inboard brake pad 306 and a second member axially movable relative to the first member. In this embodiment, the first member is in the form of a clip 352, and the second member in the form of a sleeve 354. The compliant arrangement 350 further includes a resilient element. In this embodiment, the resilient element is in the form of a spring washer 356. In this embodiment, contrary to the wear sensor assembly 30 shown in FIGS. 1A to 1C, the housing 333 of the wear sensor assembly 330 has a smaller diameter than the sacrificial member 340, but the function and components are identical to FIGS. 1A to 1C. The clip 352, sleeve 354 and spring washer 356 each have a through bore so they can locate on the housing 333 and contact the sacrificial member 340. The spring washer 356 is located intermediate the clip 352 and the sleeve 354. The components of the wear sensor assembly 330 are, in this embodiment, arranged on the axis y-y, as shown in FIG. 13.

The clip 352 is shaped to fit within the slot 318 in the backplate 312. In this embodiment, the clip 352 has an interference fit with the slot 318, but in alternative embodiments could be fixed to the backplate 312 in any suitable way. The clip 354 has a sleeve portion with a first radially extending flange 358 at a first end and a second radially extending flange 360 at an opposite second end. The first and second flanges 358, 360 are arranged to engage inboard and outboard surfaces respectively of the backplate 312 to locate the clip 352 in the axial direction. In this embodiment, the clip 352 is substantially annular but with a disconnected portion arranged to define an opening 353 such that the remainder of the wear sensor assembly 330 can be inserted into the clip 352 from above the clip 352 once it is located in the slot 318. In other words, the clip 352 is substantially U-shaped. The opening 353 is sandwiched by planar cut off portions, so the clip 352 does not project radially above the top surface of the backplate 12.

The sleeve 354 is configured to locate in the clip 352 and is slidable relative to the clip 352. The sleeve 354 is located radially inwardly of the clip 352 in this embodiment, which helps to reduce the amount of space required for the compliant arrangement 350. In this embodiment, the sleeve 354 has a sleeve portion with a first radially extending flange 366 at a first end and a second radially extending flange 368 at an opposite second end. In this embodiment, the second flange 368 extends radially to a greater extent than the first flange 366. The sleeve 354 is configured to locate within the clip 352. The first flange 366 is arranged to locate axially inboard of the first flange 358 of the clip 352 to help retain the sleeve 354 on the clip 352, i.e., to limit the sleeve 354 from moving too far in the outboard direction. In other words, the first flange 366 defines a first stop surface. The second flange 368 is arranged to locate axially outboard of the second flange 360 of the clip 352 to help limit the sleeve 354 from moving too far in the inboard direction. In other words, the second flange 368 defines a second stop surface.

The outboard facing surface of the second flange 368 contacts an inboard facing surface 370 of the sacrificial member 340. Therefore, when a force is applied to the engaging face 342 of the sacrificial member 340 during a braking operation, the force will transfer to the second flange 68 of the sleeve 354.

The spring washer 356 is arranged between opposing faces of the second flange 368 of the sleeve 354 and the second flange 360 of the clip 354. The spring washer 356 can be specifically selected to have the appropriate amount of springiness such that when a force is applied to the sleeve 354, the force will pass to the spring washer 356 via the second flange 368. In reaction, the spring washer 356 will apply a force back on the sleeve 354. In this way, the springiness of the spring washer 356 will determine how compressible the compliant arrangement 350 is. Typically, during a braking operation, the friction material 314 will compress by a maximum of 1-2 mm in the axial direction. Accordingly, a resilient element should be selected that is configured to compress by substantially the same amount to help ensure the engaging face 316 of the friction material 314 and the engaging face 342 of the sacrificial member 340 stay substantially flush. Although the resilient element is a spring washer 356 in this embodiment, it could be any suitable type of resilient element. For example, it could be a wavy washer, or a compressible spacer, or a spring.

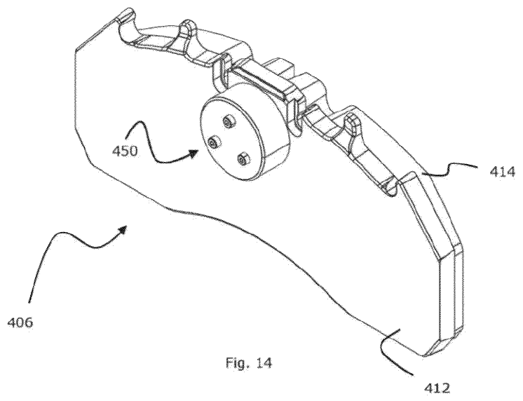

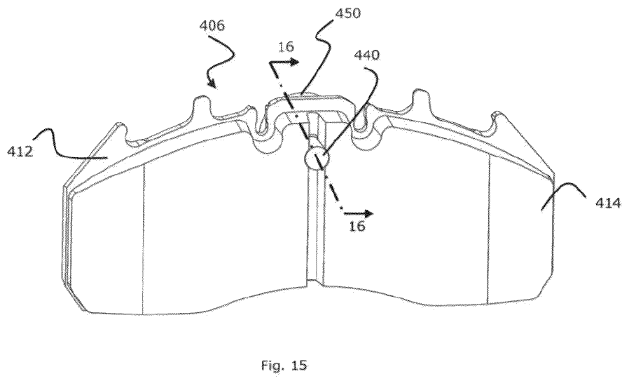

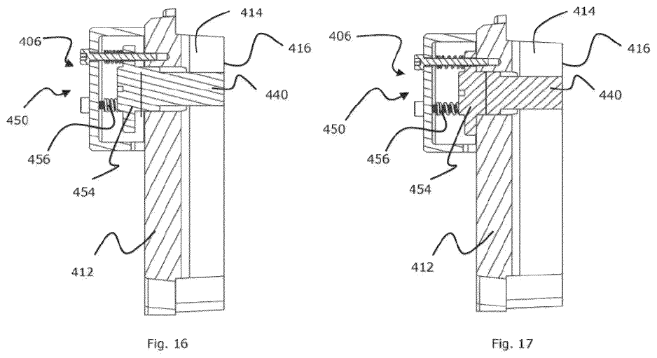

FIGS. 14 to 20 show an alternative embodiment, with a compliant arrangement 450. Only the differences from the previous embodiments will be described. Similar components will use the same reference numerals, but with the prefix “4”.

As can be seen from FIG. 14, in this embodiment, at least part of the compliant arrangement 450 is located inboard of the backplate 412 of the inboard brake pad 106.

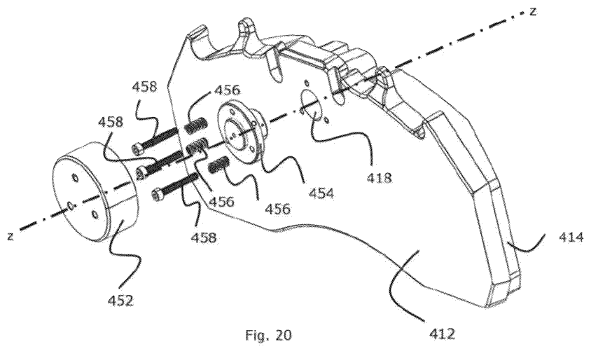

FIG. 20 shows that in this embodiment there is no slot intersecting the backplate 412 and friction material 414. Instead, a recess is defined that is spaced from the perimeter 420 of the backplate 412 and the perimeter 422 of the friction material 414. In this embodiment, the recess is a through hole 418. The through hole 418 locates at least part of the wear sensor assembly 430, as will be described in more detail below. In this embodiment, the components of the wear sensor assembly 430 are arranged on the axis z-z, as shown in FIGS. 19 and 20.

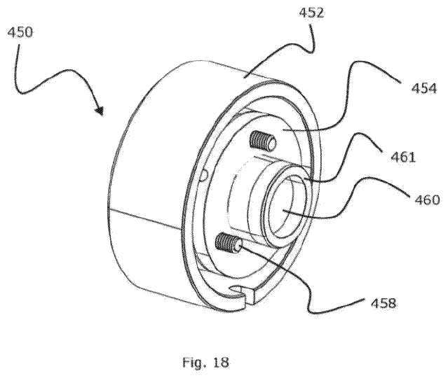

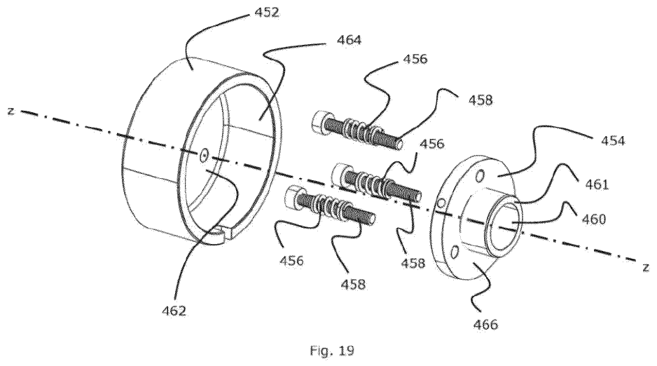

As shown most clearly in FIGS. 18 to 20, the compliant arrangement 450 has a first member fixed to the backplate 412 in the form of an enclosure 452. Radially inwardly of the enclosure 452 is a second member axially movable relative to the first member. In this embodiment, the second member is in the form of a cylinder 454.

The enclosure 452 includes an axially extending annular sleeve portion 464. At an outboard end of the sleeve portion 464 is a radially extending surface such that the enclosure 452 is substantially cup-shaped, with a blind bore defining a radial inner face 462 on the outboard facing side of the radially extending surface. The sleeve portion 464 is arranged around the axis z-z and is configured to enclose the cylinder 454. In this embodiment, the enclosure 452 is fixed to the backplate 412 with at least one elongate fastening element. In this embodiment, the enclosure 452 is fixed to the backplate 412 with three elongate fastening elements in the form of bolts 458. Each bolt 458 has a head and a shaft and the shafts are configured to be introduced from the inboard side of the enclosure through circumferentially distributed holes that extend through the radially extending surface of the enclosure 452. The heads of the bolts 458 engage the inboard face of the radially extending surface of the enclosure 452 to limit the extent of their insertion as desired. The shafts of the bolts 458 locate in corresponding threaded bores in the backplate 412. It will be appreciated that the enclosure 452 could be fixed to the backplate 412 in any other suitable way, however. For example, different types of fastening elements could be used, or it could be adhered to the backplate 412 or fixed via a suitable adhesive or welding.

The cylinder 454 has a blind bore 460 on its inboard face. The blind bore 460 is dimensioned to receive the housing 433 of the wear sensor assembly 430. An outboard facing end surface 461 of the cylinder 454 surrounds the blind bore 460 and is configured to engage the inboard facing surface 470 of the sacrificial member 440 so that force applied to the sacrificial member 440 passes to the cylinder 454. In this embodiment, the cylinder 454 has a radially projecting flange 466 at its outboard end. An outboard face of the flange 466 is configured to limit the cylinder 454 from moving too far in the outboard direction. In other words, the outboard face of the flange 466 defines a first stop surface. In this embodiment, the outboard face of the flange 466 is configured to engage the inboard face of the backplate 412 to limit the movement of the cylinder 454 in the outboard direction. The inboard face of the flange 166 is configured to limit the cylinder 454 from moving too far in the inboard direction. In other words, the inboard face of the flange 466 defines a second stop surface. In this embodiment, the inboard face of the flange 466 is configured to engage the radial inner face 462 of the enclosure 452 to limit the movement of the cylinder 454 in the inboard direction. As will be described below, however, it is unlikely that the cylinder 454 will come into contact with the enclosure 452 due to the resilient elements located between the inboard face of the flange 466 and the radial inner face 462 of the enclosure 452.

The flange 466 has through holes arranged such that the bolts 458 can pass through the holes before being fixed to the backplate 412. The holes of the flange 466 are dimensioned such that there is a clearance between them and the bolts 458. This enables the cylinder 464 to slide in an axial direction on the bolts 458, relative to the enclosure 452. Between the inboard face of the flange 466 and the radial inner face 462 of the enclosure 452 is at least one resilient element. In this embodiment, there are three resilient elements in the form of wave springs 456 that locate on three bolts 458 and engage the inboard face of the flange 466 and the radial inner face 462 of the enclosure 452. Like the previous embodiment, the wave springs 456 can be specifically selected to have the appropriate amount of springiness such that when a force is applied to the cylinder 454, the force will pass to the wave springs 456 via the flange 466. In reaction, the wave springs 456 will apply a force back on the cylinder 454. In this way, the springiness of the wave springs 456 will determine how compressible the compliant arrangement 450 is. Although each resilient element is a wave spring 456 in this embodiment, it could be any suitable type of resilient element. For example, there could simply be a single spring between the cylinder 454 and the enclosure 452 if the enclosure 452 was fixed to the backplate 412 in an alternative way.

Where the word ‘or’ appears, this is to be construed to mean ‘and/or’. This is such that items referred to are not necessarily mutually exclusive and may be used in any appropriate combination.

The present disclosure has been described above with reference to one or more specific embodiments. However, it will be appreciated that various changes and modifications can be made without departing from the scope of the present disclosure as defined in the claims.

For example, the wear sensor assemblies 330, 430 with compliant arrangements 350, 450 have been described and shown only in relation to the inboard brake pads 306, 406. However, it will be appreciated that such arrangements could also be provided for the outboard brake pads 408, 408 and would be substantially a mirror image of the arrangements for the inboard brake pads.

The braking elements described and shown are planar brake pads with backplates as the support surfaces for the friction material. However, in other embodiment, one or more of the braking elements could be curved with a brake shoe as the support surface for the friction material. The wear sensor assemblies 330, 430 are suitable for use in a range of heavy vehicle brakes, such as air-actuated, hydraulically-actuated or electrically-actuated brakes. The brakes could be disc brakes or drum brakes.

The appended claims set out particular combinations of features described above. However, the scope of the present disclosure is not limited to these particular combinations claimed. Instead, the scope of the present disclosure extends to encompass any combination of features herein disclosed.

1. A heavy vehicle brake assembly comprising:
a braking element including friction material, the braking element configured to be actuated in a braking operation in the direction of a braking surface so that an engaging face of the friction material contacts the braking surface to slow a heavy vehicle; and
a wear sensor assembly for detecting the wear of the friction material, the wear sensor assembly configured to be actuated together with the braking element during the braking operation so that an engaging face of the wear sensor assembly also contacts the braking surface,
wherein the wear sensor assembly comprises a compliant arrangement configured to allow compression of the wear sensor assembly when the engaging face of the wear sensor assembly contacts the braking surface.

2. The heavy vehicle assembly of claim 1, wherein the compliant arrangement comprises a resilient element configured to be compressed during the braking operation and expand after the braking operation to move the engaging face of the wear sensor assembly in the direction of the braking surface.

3. The heavy vehicle assembly of claim 2, wherein the compliant arrangement comprises a first member fixed relative to the braking element and a second member fixed relative to the wear sensor assembly, wherein the second member is movable relative to the first member along an axis that is perpendicular to the braking surface.

4. The heavy vehicle assembly of claim 3, wherein the resilient element is located between the first member and the second member of the compliant arrangement.

5. The heavy vehicle assembly of claim 4, wherein the resilient element is located between radially extending opposing surfaces of the first member and the second member.

6. The heavy vehicle assembly of claim 3, wherein the second member is located radially inwardly of the first member.

7. The heavy vehicle assembly of claim 1, wherein the braking element has a support surface for the friction material, at least one of the support surface and friction material comprise a slot or a recess to locate the wear sensor assembly, and the support surface and friction material each have a perimeter and the slot intersects the perimeter of the support surface and the perimeter of the friction material.

8. (canceled)

9. The heavy vehicle braking assembly of claim 7, wherein the first member of the compliant arrangement locates in the slot of the support surface and is fixed to the support surface of the braking element, optionally wherein the first member is a clip configured to locate in the slot of the support surface with an interference fit and the second member is a sleeve configured to slide within the clip, optionally wherein the slot and the clip are substantially U-shaped.

10. The heavy vehicle braking assembly of claim 7, wherein the support surface and friction material each have a perimeter and comprise a recess in the form of a through hole spaced from the perimeter of the support surface and the perimeter of the friction material.

11. ) The heavy vehicle braking assembly of claim 10, wherein at least a portion of the second member of the compliant arrangement locates in the through hole of the support surface and the first member is fixed to the support surface of the braking element, optionally wherein the second member is fixed to the support surface by an elongate fastening element, optionally wherein the first member is configured to slide on the fastening element relative to the second member, optionally where the fastening element locates a resilient element.

12. The heavy vehicle braking assembly of claim 3, wherein the extent of relative movement between the first member and the second member is limited by at least one stop surface, the braking element has a support surface for the friction material and the stop surface is on the second member and is configured to contact the support surface or the first member to limit return movement towards the braking surface, and the stop surface is a first stop surface and the second member further comprises a second stop surface for contacting the support surface of the first member to limit actuation movement away from the braking surface.

13.-14. (canceled)

15. The heavy vehicle braking assembly of claim 1, wherein the wear sensor assembly further comprises:
an ultrasonic sensor for emitting and detecting high-frequency sound waves; and
a sacrificial member having the engaging face of the wear sensor assembly that is arranged to face the braking surface,
wherein the sacrificial member is arranged such that sound waves emitted by the ultrasonic sensor pass through the sacrificial member.

16. A heavy-vehicle brake assembly, comprising:
a braking element including friction material having an engaging face, the braking element configured to be actuated in a braking operation so that the engaging face of the friction material engages a braking surface to slow a heavy-vehicle; and
a wear sensor assembly comprising:
an ultrasonic sensor for emitting and detecting high-frequency sound waves; and
a sacrificial member having an engaging face arranged to face the braking surface,
wherein the sacrificial member is arranged such that sound waves emitted by the ultrasonic sensor pass through the sacrificial member;
wherein the engaging face of the sacrificial member is flush with the engaging face of the friction material of the braking element and the sacrificial member is configured to actuate together with the braking element during the braking operation so that the engaging face of the sacrificial member also engages the braking surface.

17. The heavy-vehicle brake assembly of claim 16, wherein the sacrificial member is fixed relative to the braking element.

18. (canceled)

19. The heavy-vehicle brake assembly of claim 16, wherein the braking element comprises a recess extending through the friction material, and the sacrificial member is located within the recess, and the recess in the friction material is spaced from radial and circumferential edges of the braking element.

20. (canceled)

21. The heavy-vehicle brake assembly of claim 16, wherein the sacrificial member is arranged between the ultrasonic sensor and the braking surface and is fixed to the ultrasonic sensor.

22. (canceled)

23. The heavy-vehicle brake assembly of claim 16, wherein the sacrificial member is elongate and arranged with its longitudinal axis extending in a direction perpendicular to the engaging face of the friction material of the braking element.

24. The heavy-vehicle brake assembly of claim 23, wherein the sacrificial member is cylindrical and located within a corresponding cylindrical recess of a housing arranged to locate the ultrasonic sensor.

25. (canceled)

26. (canceled)

27. A drum brake comprising the heavy-vehicle brake assembly of claim 16, wherein the braking surface is an inner surface of a drum rotationally fixed relative to a vehicle wheel and the braking element is a brake shoe having brake linings of friction material.

28. (canceled)

29. A disc brake comprising the heavy-vehicle brake assembly of claim 16, wherein the braking surface is a rotor rotationally fixed relative to a vehicle wheel and the braking element is a brake pad having friction material, optionally wherein the brake pad has a backplate and the friction material is fixed to the backplate.

30. (canceled)
